(19) United States
(12) Patent Application Publication
(10) Pub. No.: US 2007/0124600 A1
(43) Pub. Date: May 31, 2007

(54) Work system with an automatic OS login function and method for using the same

(75) Inventors: Yi-Tsung Huang, Hsin-Tien City (TW); Shih-Chi Cheng, Hsin-Tien City (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORPORATION

(21) Appl. No.: 11/602,400

(22) Filed: Nov. 21, 2006

(30) Foreign Application Priority Data
Nov. 29, 2005 (TW) 94141951

(51) Int. Cl. H04K 1/00

(52) U.S. Cl. 713/186

(57) ABSTRACT

A work system with an automatic OS login function includes a fingerprint mobile disk and a computer device. The fingerprint mobile disk has a fingerprint capturing unit and a storage unit. The computer device electrically connects to the fingerprint mobile disk. The computer device has a built-in OS, a login password setting unit for setting a domain name, a user name, and an OS login password according to the fingerprint information, and a login password key-in unit that acts as an interface for entering the OS. The domain name, the user name, and the OS login password are stored in the storage unit. When the user turns on the computer device and enters the login password key-in unit, the user automatically enters the OS via the login password key-in unit reading the domain name, the user name and the OS login password from the storage unit.

### BACKGROUND OF THE INVENTION

1. Field of the Invention

The present invention relates to a work system with an automatic OS (Operating System) login function and a method for using the same, and particularly relates to a computer device's OS being automatically entered by a user via a login password that is stored in a fingerprint mobile disk that is plugged into a computer device.

2. Description of the Related Art

Recent developments in science and technology have led to many computer devices such as PCs, notebooks or PDAs with OSs (Operating System) being applied extensively throughout to the many realms of a modern person's life. This is especially true when it comes to PCs and notebooks. For these devices, a user requires to key-in a login password to obtain authorization to use the PC or notebook.

Moreover, in recent years a fingerprint identification device has been combined with the computer device. Hence, after a user's fingerprint has been identified via the fingerprint identification device, the computer device can verify the user's identity and provide different access rights according to different identities. Therefore, the computer device can control and manage different users in order to assure the safety of the stored therein.

However, in the prior art when a user wants to login to the OS each time, the user requires to key-in a login password or use the fingerprint identification device to capture the user's fingerprint (the user's fingerprint facing down and sliding on to the fingerprint identification device) in order to login. Hence, the known login method is slow (the known method requires keying-in a login password or using the fingerprint identification device each time) and inaccurate (the known user's fingerprint needs to be scanned many times before an accurate fingerprint can be obtained).

### SUMMARY OF THE INVENTION

The present invention provides a work system with an automatic OS (Operating System) login function and a method for using the same. The present invention helps a user to automatically, quickly and efficiently enter a computer device's OS via a domain name, a user name, and an OS login password that all are stored in a fingerprint mobile disk that is plugged into a computer device.

A first aspect of the invention is a work system with an automatic OS (Operating System) login function, comprising: a fingerprint mobile disk and a computer device. The fingerprint mobile disk has a fingerprint capturing unit that captures a user's fingerprint information and a storage unit that stores the fingerprint information of the user. The computer device is electrically connected with the fingerprint mobile disk. In addition, the computer device has a built-in OS, a login password setting unit for setting a domain name, a user name, and an OS login password according to the user's fingerprint information, and a login password key-in unit as an interface for entering the OS. Furthermore, the domain name, the user name and the OS login password are stored in the storage unit. When the user turns on the computer device and enters the login password key-in unit, the user automatically enters the computer device's OS via the login password key-in unit reading the domain name, the user name and the OS login password from the storage unit of the fingerprint mobile disk.

A second aspect of the invention is a method for using a work system with an automatic OS (Operating System) login function, comprising: electrically connecting a fingerprint mobile disk with a computer device; capturing a user's fingerprint information via a fingerprint capturing unit of the fingerprint mobile disk; authorizing the user to set a domain name, a user name, and an OS login password in a login password setting unit of the computer device via the user's fingerprint information; respectively storing the domain name, the user name and the OS login password in a storage unit of the fingerprint mobile disk; resetting the computer device in order to enter a login password key-in unit of the computer device; and reading the domain name, the user name and the OS login password from the storage unit of the fingerprint mobile disk via the login password key-in unit of the user wishing to automatically enter the computer device's OS.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block of a work system with an automatic OS (Operating System) login function according to the present invention; and

FIG. 2 is a flowchart of a method for using a work system with an automatic OS (Operating System) login function of the present invention.

### DETAILED DESCRIPTION OF PREFERRED EMBODIMENTS

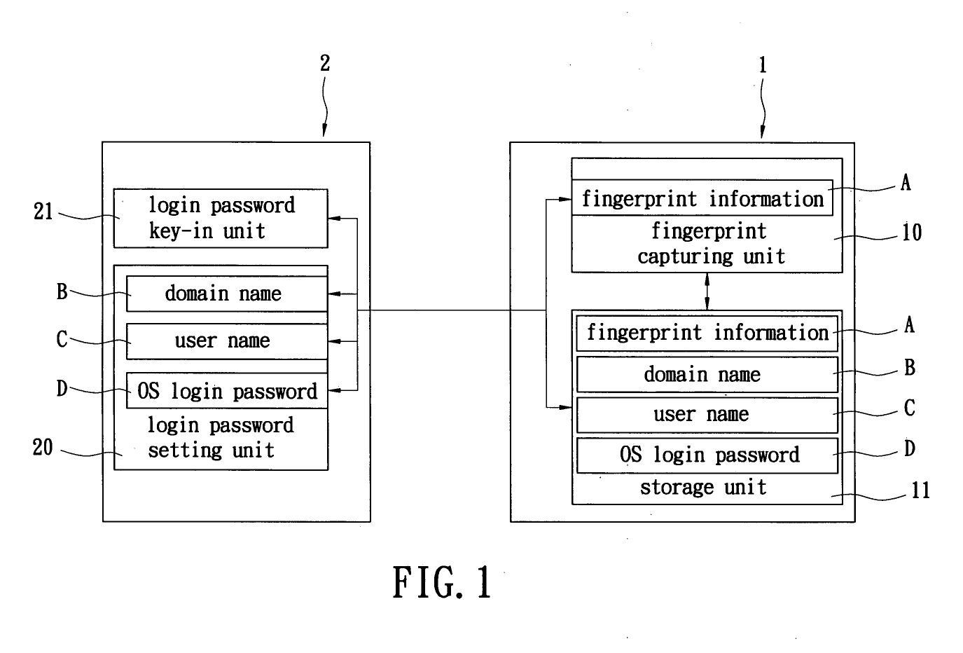

Referring to FIG. 1, the present invention provides a work system with an automatic OS (Operating System) login function, comprising: a fingerprint mobile disk 1 and a computer device 2.

The fingerprint mobile disk 1 has a fingerprint capturing unit 10 and a storage unit 11. The fingerprint capturing unit 10 is used to capture a user's fingerprint information A and the storage unit 11 is used to store the fingerprint information A of the user. The storage unit 11 can be a NVRAM (Non-Volatile Random Access Memory).

Moreover, the computer device 2 is electrically connected with the fingerprint mobile disk 1. The computer device 2 has a built-in OS stored therein. In addition, the computer device 2 has a login password setting unit 20 and a login password key-in unit 21. The login password setting unit 20 is used to set a domain name B, a user name C, and an OS login password D according to the user's fingerprint information A. The domain name B, the user name C, and the OS login password D are all stored in the storage unit 11. Furthermore, the login password key-in unit 21 can be an interface for entering the OS, When the user turns on the computer device 2 and enters the login password key-in unit 21, the user can automatically enter the OS of the computer device 2 via the login password key-in unit 21 reading the domain name B, the user name C, and the OS login password D from the storage unit 11 of the fingerprint mobile disk 1.

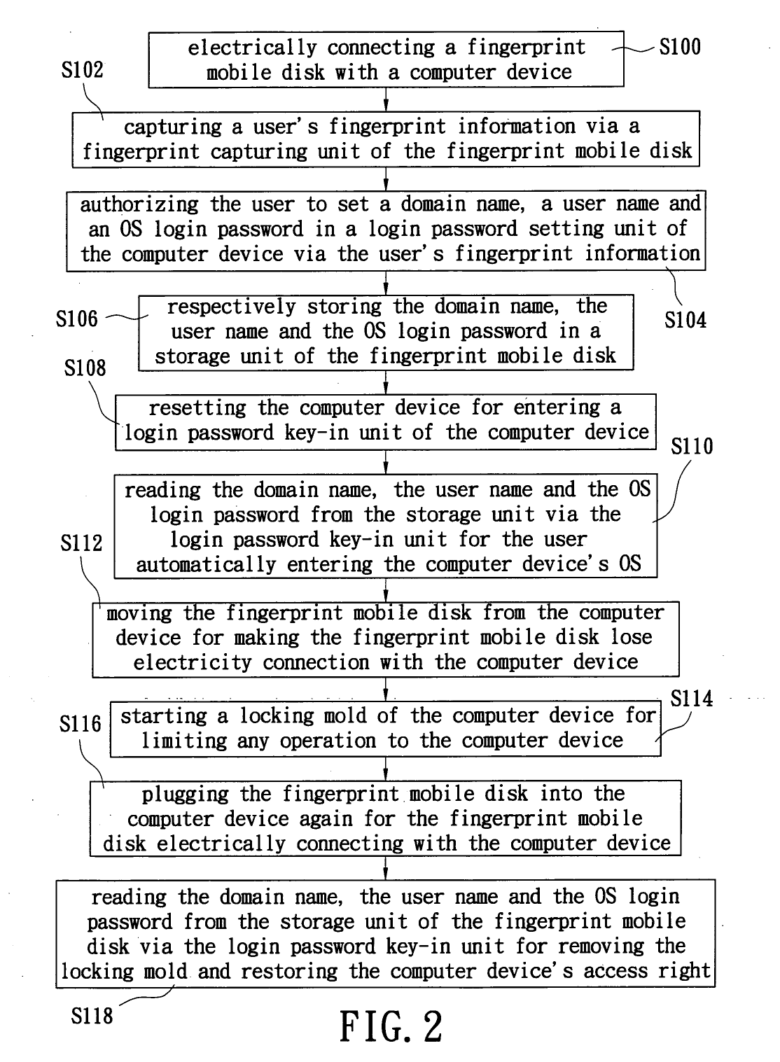

Referring to FIG. 2, the present invention provides a method for using a work system with an automatic OS (Operating System) login function, comprising: electrically connecting a fingerprint mobile disk 1 with a computer device 2 (S100); capturing a user's fingerprint information A via a fingerprint capturing unit 10 of the fingerprint mobile disk 1 (S102); and, authorizing the user to set a domain name B, a user name C, and an OS login password D in a login password setting unit 20 of the computer device 2 via the user's fingerprint information A (S104). In addition, the entire information of the domain name B, the user name C, and the OS login password D are used to login to the OS of the computer device 2.

The method further comprises: respectively storing the domain name B, the user name C, and the OS login password D in a storage unit 11 of the fingerprint mobile disk 1 (S106); resetting the computer device 2 in order to enter a login password key-in unit 21 of the computer device 2 (S108); and reading the domain name B, the user name C, and the OS login password D from the storage unit 11 of the fingerprint mobile disk 1 via the login password key-in unit 21 so that the user may automatically enter the OS of the computer device 2 (S110).

The method further comprises: disconnecting the fingerprint mobile disk 1 from the computer device 2 so that the fingerprint mobile disk 1 is no longer electrically connected with the computer device 2 (S112); entering a locking mode of the computer device 2 in order to limit operation of the computer device 2 (S114); plugging the fingerprint mobile disk 1 into the computer device 2 again so that the fingerprint mobile disk 1 electrically connects with the computer device 2 (S116); and, reading the domain name B, the user name C, and the OS login password D from the storage unit 11 of the fingerprint mobile disk 1 via the login password key-in unit 21 and then exiting the locking mode and restoring the user's access to the computer device (S118).

In conclusion, the present invention helps the user to automatically, quickly and efficiently enter the computer device's OS via the domain name B, the user name C, and the OS login password D that all are stored in the fingerprint mobile disk 1 plugging in the computer device 2.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A work system with an automatic OS (Operating System) login function, comprising:
a fingerprint mobile disk having a fingerprint capturing unit for capturing a user's fingerprint information and a storage unit for storing the fingerprint information of the user; and
a computer device electrically connected with the fingerprint mobile disk, wherein the computer device has a built-in OS, a login password setting unit for setting a domain name, a user name, and an OS login password according to the user's fingerprint information, and a login password key-in unit that acts as an interface for entering the OS, wherein the domain name, the user name and the OS login password are stored in the storage unit;
whereby, when the user turns on the computer device and enters the login password key-in unit, the user automatically enters the computer device's OS via the login password key-in unit reading the domain name, the user name and the OS login password from the storage unit of the fingerprint mobile disk.

2. A method for using a work system with an automatic OS (Operating System) login function, comprising:
electrically connecting a fingerprint mobile disk with a computer device;
capturing a user's fingerprint information via a fingerprint capturing unit of the fingerprint mobile disk;
authorizing the user to set a domain name, a user name, and an OS login password in a login password setting unit of the computer device via the user's fingerprint information;
respectively storing the domain name, the user name, and the OS login password in a storage unit of the fingerprint mobile disk;
resetting the computer device in order to enter a login password key-in unit of the computer device; and
reading the domain name, the user name, and the OS login password from the storage unit of the fingerprint mobile disk via the login password key-in unit so that the user automatically enters the computer device's OS.

3. The method as claimed in claim 2, wherein after the step of the user automatically entering the computer device's OS, the method further comprises:
disconnecting the fingerprint mobile disk from the computer device so that the fingerprint mobile disk is no longer electricity connected with the computer device;
entering a locking mode of the computer device to stop operation with the computer device;
reconnecting the fingerprint mobile disk into the computer device again so that the fingerprint mobile disk electrically connects with the computer device; and
reading the domain name, the user name, and the OS login password from the storage unit of the fingerprint mobile disk via the login password key-in unit to exit the locking mode and restore the user's access rights to the computer device.
